(19) United States
(12) Patent Application Publication
(10) Pub. No.: US 2016/0353490 A1
(43) Pub. Date: Dec. 1, 2016

(54) METHOD AND APPARATUS FOR ACQUIRING NETWORK STATUS DATA

(71) Applicant: ALIBABA GROUP HOLDING LIMITED, George Town (KY)

(72) Inventor: Yong ZOU, Hangzhou (CN)

(73) Assignee: ALIBABA GROUP HOLDING LIMITED

(21) Appl. No.: 15/167,658

(22) Filed: May 27, 2016

(30) Foreign Application Priority Data
May 27, 2015 (CN) 201510278065.7

(51) Int. Cl. H04W 76/02; H04L 29/12; H04L 12/26; H04W 4/02

(52) U.S. Cl. CPC H04W 76/02; H04W 4/02; H04L 61/6063; H04L 43/0876

(57) ABSTRACT

A method for acquiring network status data is provided. The method is performed by a mobile equipment emulator controller and comprises establishing a link with a first mobile equipment emulator, transmitting, over the link, an operation reporting instruction to the first mobile equipment emulator, and receiving, over the link, the network status data from the first mobile equipment emulator, after the operation reporting instruction is transmitted. The operation reporting instruction is associated with a set of operations to be performed by the first mobile equipment emulator to acquire network status data. The operation reporting instruction is configured to cause the mobile equipment emulator to perform the set of operations.

### CROSS-REFERENCE TO RELATED APPLICATION

This application is based upon and claims priority to Chinese Patent Application No. 201510278065.7, filed May 27, 2015, the entire contents of which are incorporated herein by reference.

### TECHNICAL FIELD

The present disclosure generally relates to the field of computer technology and, more particularly, to a method and an apparatus for acquiring network status data.

### BACKGROUND

As 3G and 4G wireless networks become increasingly accessible, wireless access becomes an important way to access networks. However, the wireless access failure rate is typically much higher than the wired access failure rate, because a wireless network has limited bandwidth resource, and that wireless network environment can be unstable. When a mobile equipment emulator attempts to access a website hosted by a server and fails, the server can determine a solution to solve the access failure in a timely manner, if the server can acquire information about a status of the network in which the mobile equipment emulator is located.

Under current technologies, the server can only obtain network status information through the reports of access failures by the mobile equipment emulator, but cannot actively monitor the networks. In addition, not all of the mobile equipment emulator transmit the access failure information to the server. The server can only obtain scattered information, but cannot consistently track network status.

### SUMMARY

As discussed above, under current technologies, a mobile equipment emulator can initiate a transmission of network status data to a server, so that the server can detect an access failure and to determine a solution to solve the access failure. However, the mobile equipment emulator may also not transmit the information to the server, and there is a lack of control and coordination over the acquisition of the network status data.

To solve the problems under the current technology, embodiments of the present disclosure provide a method and an apparatus for acquiring network status data. In particular, the present disclosure provides an apparatus (e.g., a mobile equipment emulator controller) can cause a mobile equipment emulator to acquire and to transmit network status data. The apparatus can also configure the mobile equipment emulator to transmit network status data continuously and periodically over a period of time, and to coordinate the acquisition of network status data between different devices.

Embodiments of the present disclosure provide a method of acquiring network status data, the method being performed by a mobile equipment emulator controller. The method comprises: establishing a link with a first mobile equipment emulator; transmitting, over the link, an operation reporting instruction to the first mobile equipment emulator, wherein the operation reporting instruction is associated with a set of operations to be performed by the first mobile equipment emulator to acquire network status data, and wherein the operation reporting instruction is configured to cause the first mobile equipment emulator to perform the set of operations; and receiving, over the link, the network status data from the first mobile equipment emulator, after the operation reporting instruction is transmitted.

In some embodiments, the method further comprises: acquiring configuration data that stores information associated with a plurality of mobile equipment emulator including the first mobile equipment emulator configured to receive one or more operation reporting instructions from the mobile equipment emulator controller; determining to establish the link with the first mobile equipment emulator based on the configuration data; and storing a mapping between the link and the first mobile equipment emulator.

In some embodiments, the configuration data includes location information of the first mobile equipment emulator; and wherein the determination to establish the link is based on the location information.

In some embodiments, the method further comprises: creating an independent thread for transmitting the operation reporting instruction; and mapping the operation reporting instruction to independent thread.

In some embodiments, the method further comprises: determining a mode of acquiring network status data; generating indication information associated with the mode of acquiring network status data; and transmitting the indication information with the operation reporting instruction to the first mobile equipment emulator.

In some embodiments, the mode of acquiring network status data includes an interactive operation mode, wherein the operation reporting instruction is configured to cause the first mobile equipment emulator to transmit an access request for network resources to the server. The mode of acquiring network status data can also include a local operation mode, wherein the operation reporting instruction is configured to cause the first mobile equipment emulator to transmit a network connectivity diagnosis command to the server.

Embodiments of the present disclosure also provide a non-transitory computer readable medium storing instructions that are executable by one or more processors to cause the one or more processors to execute the aforementioned method of acquiring network status data.

Embodiments of the present disclosure further provide a mobile equipment emulator controller for acquiring network status data. The mobile equipment emulator controller may comprise: a memory device that stores a set of instructions; and a hardware processor configured to execute the set of instructions to: establish a link with a first mobile equipment emulator; transmit, over the link, an operation reporting instruction to the first mobile equipment emulator, wherein the operation reporting instruction is associated with a set of operations to be performed by the first mobile equipment emulator to acquire network status data, and wherein the operation reporting instruction is configured to cause the first mobile equipment emulator to perform the set of operations; and receive, over the link, the network status data from the first mobile equipment emulator, after the operation reporting instruction is transmitted.

In some embodiments, the hardware processor is further configured to execute the set of instructions to: acquire configuration data that stores information associated with a plurality of mobile equipment emulator including the first mobile equipment emulator configured to receive one or more operation reporting instructions from the mobile equipment emulator controller; determine to establish the link with the first mobile equipment emulator based on the configuration data; and store a mapping between the link and the first mobile equipment emulator.

In some embodiments, the configuration data includes location information of the first mobile equipment emulator; and wherein the determination to establish the link is based on the location information.

In some embodiments, the hardware processor is further configured to execute the set of instructions to: create an independent thread for transmitting the operation reporting instruction; and map the operation reporting instruction to the independent thread.

In some embodiments, the hardware processor is further configured to execute the set of instructions to: determine a mode of acquiring network status data; generate indication information associated with the mode of acquiring network status data; and transmit the indication information with the operation reporting instruction to the first mobile equipment emulator.

In some embodiments, the mode of acquiring network status data includes an interactive operation mode, wherein the operation reporting instruction is configured to cause the first mobile equipment emulator to transmit an access request for network resources to the server. The mode of acquiring network status data may also include a local operation mode, wherein the operation reporting instruction is configured to cause the first mobile equipment emulator to transmit a network connectivity diagnosis command to the server.

With embodiments of the present disclosure, an apparatus (e.g., a mobile equipment emulator controller) can transmit an operation reporting instruction to a mobile equipment emulator, to cause the mobile equipment emulator to acquire and transmit network status data. The apparatus can also configure the mobile equipment emulator to transmit network status data continuously and periodically over a period of time, and to coordinate the acquisition of network status data between different devices. The mobile equipment emulator controller can control a plurality of mobile equipment emulator distributed across different geographical locations to acquire network status data in those locations. Based on the network status data, the mobile equipment emulator controller (or some other apparatuses) can detect or predict network access failure, and provide notification about the failure. Further, since specific instructions for acquiring network status data are provided to the mobile equipment emulator, any updates to the operations of acquiring network status data can be made at the mobile equipment emulator controller, thereby enhancing the scalability of the system.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a flowchart illustrating an exemplary method for acquiring network status data, consistent with embodiments of the present disclosure.

FIG. 2 is a flowchart illustrating exemplary sub-steps of exemplary method for acquiring network status data of FIG. 1.

FIG. 3 is a block diagram illustrating an exemplary distributed system for acquiring network status data, consistent with embodiments of the present disclosure.

FIG. 4 is a flowchart illustrating exemplary sub-steps of exemplary method for acquiring network status data of FIG. 1.

FIG. 5 is a flowchart illustrating an exemplary method for acquiring network status data of FIG. 1.

FIG. 6 is a block diagram illustrating an exemplary system for acquiring network status data, consistent with embodiments of the present disclosure.

FIG. 7 is a block diagram illustrating an exemplary mobile equipment emulator controller for acquiring network status data, consistent with embodiments of the present disclosure.

FIG. 8 is a block diagram illustrating an exemplary mobile equipment emulator for acquiring network status data, consistent with embodiments of the present disclosure.

FIG. 9 is a block diagram illustrating an exemplary system for acquiring network status data, consistent with embodiments of the present disclosure.

FIG. 10 is a block diagram illustrating an exemplary system for acquiring network status data, consistent with embodiments of the present disclosure.

FIG. 11 is a block diagram illustrating another exemplary system for acquiring network status data, consistent with embodiments of the present disclosure.

### DESCRIPTION OF THE EMBODIMENTS

To solve the problems under the current technologies, embodiments of the present disclosure provide a method and an apparatus for acquiring network status data. The present disclosure provides an apparatus (e.g., a mobile equipment emulator controller) that can cause a mobile equipment emulator to transmit network status data. According to some embodiments, the apparatus can also configure the mobile equipment emulator to transmit network status data continuously and periodically, and to coordinate the acquisition of network status data between different devices.

Embodiments of the present disclosure provide a method of acquiring network status data, the method being performed by a mobile equipment emulator controller. The method comprises: establishing a link with a first mobile equipment emulator; transmitting, over the link, an operation reporting instruction to the first mobile equipment emulator, wherein the operation reporting instruction is associated with a set of operations to be performed by the first mobile equipment emulator to acquire network status data, and wherein the operation reporting instruction is configured to cause the first mobile equipment emulator to perform the set of operations; and receiving, over the link, the network status data from the first mobile equipment emulator, after the operation reporting instruction is transmitted.

With embodiments of the present disclosure, an apparatus (e.g., a mobile equipment emulator controller) can transmit an operation reporting instruction to a mobile equipment emulator, to cause the mobile equipment emulator to acquire and transmit network status data. The apparatus can also configure the mobile equipment emulator to transmit network status data continuously and periodically over a period of time, and to coordinate the acquisition of network status data between different devices. The mobile equipment emulator controller can control a plurality of mobile equipment emulator distributed across different geographical locations to acquire network status data in those locations. Based on the network status data, the mobile equipment emulator controller (or some other apparatuses) can detect or predict network access failure, and provide notification about the failure. Further, since specific instructions for acquiring network status data are provided to the mobile equipment emulator, any updates to the operations of acquiring network status data can be made at the mobile equipment emulator controller, thereby enhancing the scalability of the system.

Reference will now be made in detail to methods and specific implementations that seek to overcome the foregoing shortcomings of current systems and methods for facilitating the login of an account. Examples of these implementations are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

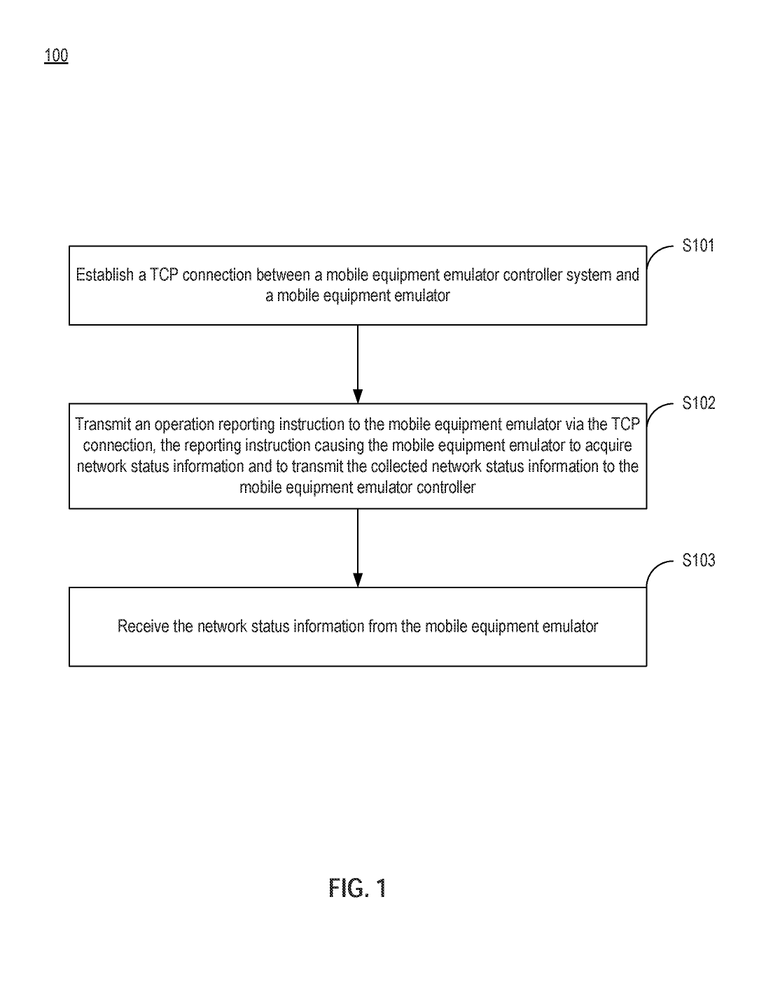

Reference is now made to FIG. 1, which illustrates an exemplary method 100 for acquiring network status data, according to embodiments of the present disclosure. The method can be performed by, for example, a mobile equipment emulator controller. The mobile equipment emulator controller can be collocated with a server, and can be communicatively coupled with a mobile equipment emulator that is located in an area for which the server provides network resources. The area can include a certain geographical region associated with a website, and can be application specific. The mobile equipment emulator can be a device with the capability of connecting with the server and accessing the network resources hosted by the server. The mobile equipment emulator emulator can be configured to emulate one or more functionalities of the mobile device.

In step S101, the mobile equipment emulator controller establishes a link, such as a TCP (Transmission Control Protocol) connection, with the mobile equipment emulator.

In some embodiments, the mobile equipment emulator can be controlled by the mobile equipment emulator controller to transmit an access request for network resources to the server. In some embodiments, a plurality of mobile equipment emulator can be positioned in the area, each controlled by the mobile equipment emulator controller. As discussed above, the area can include a certain geographical region associated with a website, and can be application specific. There is also no limit to the size of the area, and any number of the mobile equipment emulator can be disposed in the area.

In step S102, the mobile equipment emulator controller transmits an operation reporting instruction to the mobile equipment emulator via the TCP connection. The operation reporting instruction can cause the mobile equipment emulator to perform operations according to the operation reporting instruction, which include acquiring network status data and transmitting the collected information to the mobile equipment emulator controller.

In some embodiments, the operation reporting instruction can be associated with a local operation mode or an interactive operation mode. Under the local operation mode, the operation reporting instruction can be associated with a network connectivity diagnosis command such as, for example, a ping command or a traceroute command. The operation reporting instruction can then cause the mobile equipment emulator to transmit the ping command or the traceroute command to the server. Under the interactive operation mode, the operation reporting instruction can cause the mobile equipment emulator to transmit an access request for network resources to the server and to receive a response from the server, which can indicate whether normal access is permitted. Also, under the interactive operation mode, the operation reporting instruction can cause the mobile equipment emulator to transmit a request to view messages, which can indicate whether there is unauthorized modification of the network resources (e.g., contents of a web page).

In some embodiments, the mobile equipment emulator controller can transmit an operation reporting instruction to the mobile equipment emulator periodically at pre-determined intervals. The operation reporting instruction to be transmitted can also be pre-determined based on certain criteria, or based on the network status data returned from the mobile equipment emulator. The network status data can include, for example, accessibility of a website hosted by the server, information indicating reasons for access failures, etc.

In step S103, the mobile equipment emulator controller receives network status data from the mobile equipment emulator.

In some embodiments, after receiving the network status data, the mobile equipment emulator controller can determine the accessibility of network resources provided by the server, based on the network status data. The mobile equipment emulator controller can also store and display the network status data.

With embodiments of the present disclosure, the mobile equipment emulator controller can acquire network status data continuously and periodically, and can coordinate the acquisition of network status data between different devices.

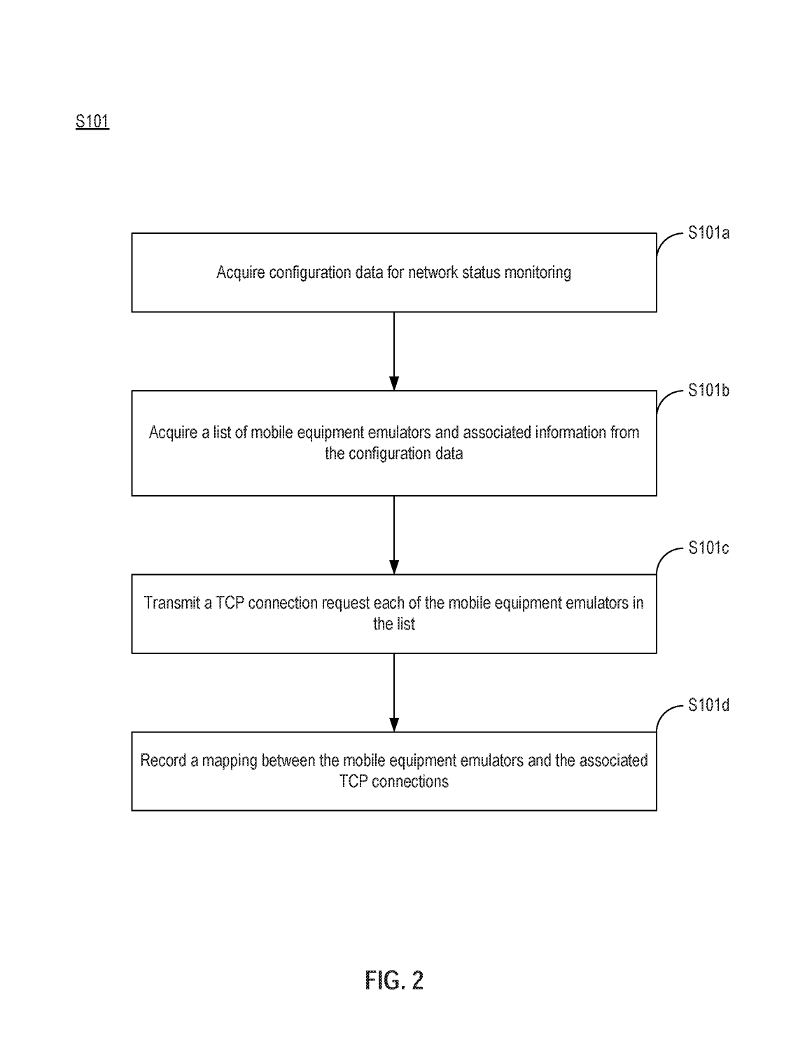

Reference is now made to FIG. 2, which illustrates exemplary sub-steps of step S101 of method 100 of FIG. 1, in which the mobile equipment emulator controller establishes a TCP connection with the mobile equipment emulator.

In step S101a, the mobile equipment emulator controller acquires configuration files for network status monitoring.

In some embodiments, the mobile equipment emulator controller may pre-set configuration files for the mobile equipment emulator that the mobile equipment emulator controller is going to monitor. The configuration files can include a list of one or more mobile equipment emulator that can receive operation reporting instructions from the mobile equipment emulator controller, as well as information associated with each of the mobile equipment emulator in the list.

In step S101b, the mobile equipment emulator controller extracts the list of mobile equipment emulators from the configuration files, and based on the list, the mobile equipment emulator controller acquires information associated the mobile equipment emulators in the list.

In some embodiments, the information associated with the mobile equipment emulator can include, for example, location information (e.g., information about the area where the equipment is located), identification information (e.g., serial code of the mobile equipment emulator), functionalities information, etc.

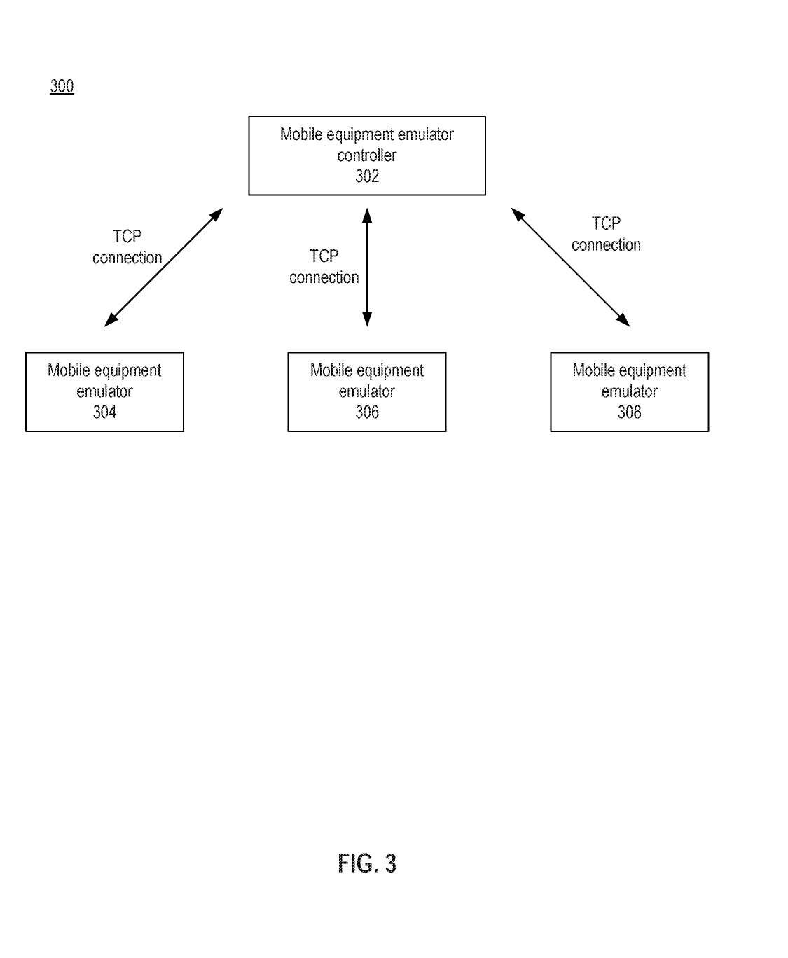

In step S101c, the mobile equipment emulator controller transmits a TCP connection request to the mobile equipment emulators in the list, to establish a TCP connection with each of the mobile equipment emulator respectively. The determination of which mobile equipment emulator to transmit the TCP connection can be based on, for example, location information of the mobile equipment emulator. For example, the mobile equipment emulator controller can determine to establish a TCP connection with mobile equipment emulator located in different areas for which a server provides network resources, to form a distributed system for acquiring network status data, such as a distributed system 300 illustrated in FIG. 3, which includes a mobile equipment emulator controller 302 communicatively coupled with mobile equipment emulator 304, 306, and 308 via TCP connections.

Referring back to FIG. 2, in step S101d, the mobile equipment emulator controller records a mapping relationship between an established TCP connection and a mobile equipment emulator with which the TCP connection was established. This enables the mobile equipment emulator controller to transmit other data (e.g., operation reporting instruction) to a mobile equipment emulator using the established TCP connection.

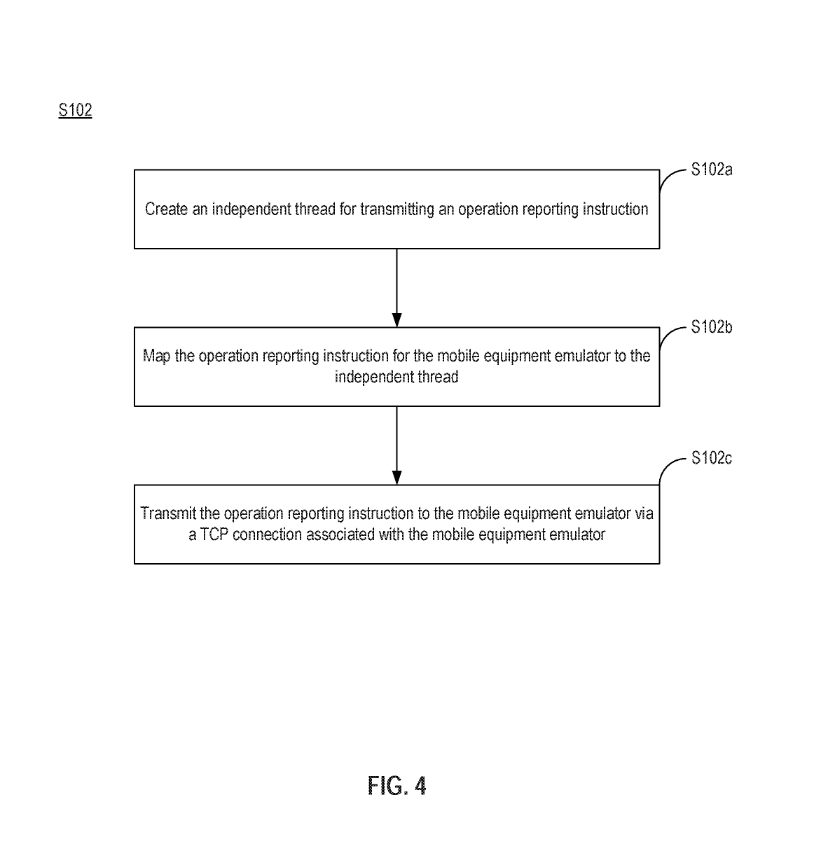

Reference is now made to FIG. 4, which illustrates exemplary sub-steps of step S102 of method 100 of FIG. 1, in which the mobile equipment emulator controller transmits an operation reporting instruction to a mobile equipment emulator.

In step S102a, the mobile equipment emulator controller creates an independent thread for each of the mobile equipment emulators for transmitting an operation reporting instruction.

In step S102b, the mobile equipment emulator controller maps the operation instruction for a mobile equipment emulator to an independent thread. In some embodiments, the mapping can be performed by associating the mobile equipment emulator with the independent thread.

In step S102c, the mobile equipment emulator controller transmits the operation reporting instruction to the mobile equipment emulator via a TCP connection associated with the mobile equipment emulator.

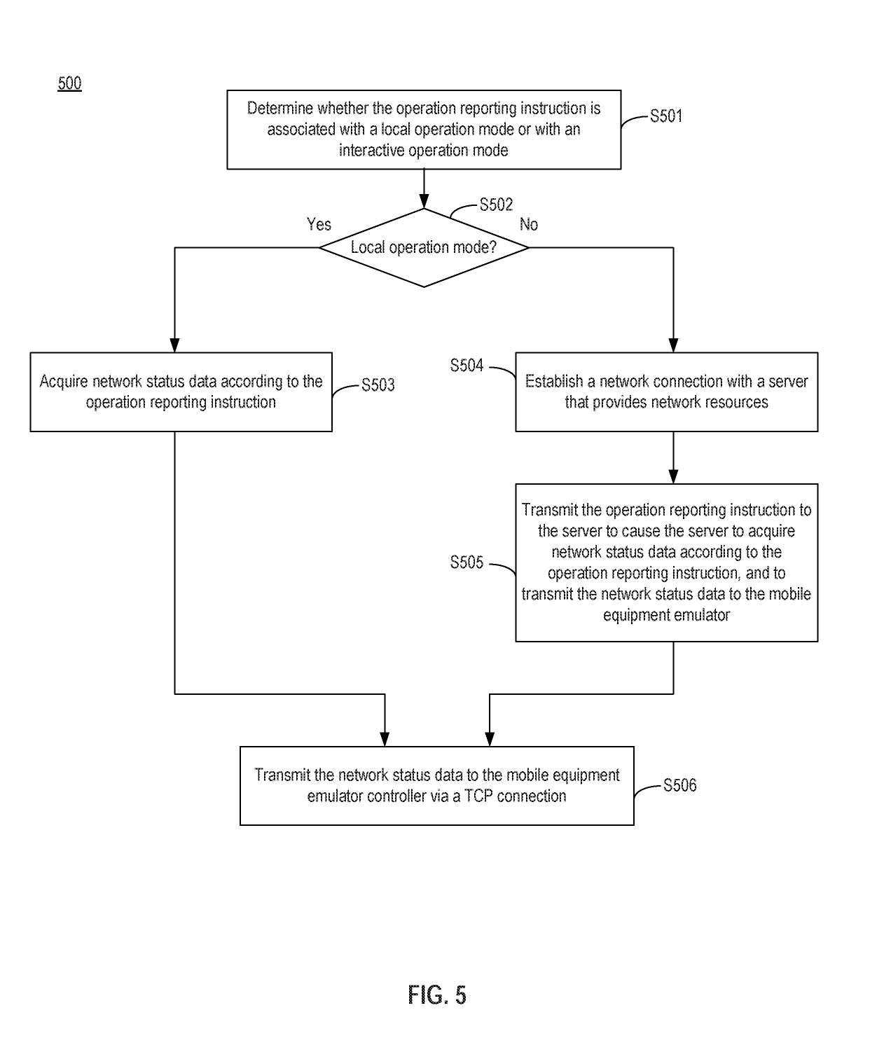

After receiving the operation reporting instruction, the mobile equipment emulator can then acquire the network status information according to the instruction. Reference is now made to FIG. 5, which illustrates an exemplary method 500 that can be performed by a mobile equipment emulator (e.g., mobile equipment emulator 304 of FIG. 3) to acquire the network status information, after receiving an operation reporting instruction from a mobile equipment emulator controller (e.g., mobile equipment emulator controller 302 of FIG. 3).

In step S501, the mobile equipment emulator determines whether the operation reporting instruction is associated with a local operation mode or with an interactive operation mode.

If the mobile equipment emulator determines that the operation reporting instruction is associated with a local operation mode, in step S502, the mobile equipment emulator can then acquire network status data according to the operation reporting instruction, in step S503. As discussed before, under local operation mode, the mobile equipment emulator can transmit a network connectivity diagnosis command such as a ping command, a traceroute command, etc., to a server that provides network resources for an area in which the mobile equipment emulator is located.

On the other hand, if the mobile equipment emulator determines that operation reporting instruction is associated with an interactive operation mode, in step S502, the mobile equipment emulator can establish a network connection (e.g., a wireless connection) with a server (e.g., a server that provides network resources for an area in which the mobile equipment emulator is located), in step S504. The mobile equipment emulator can then transmit the operation reporting instruction (or some other information generated based on the operation reporting instruction) to the server via the network connection, to cause the server to acquire network status data according to the operation reporting instruction. As discussed before, under the interactive operation mode, the mobile equipment emulator may transmit an access request or a view message request to the server, which can then provide a response to the request, and the response can include information related to the network status.

After receiving network status data either in local operation mode (e.g., in step S503) or in interactive operation mode (e.g., in step S505), the mobile equipment emulator can transmit the network status data to the mobile equipment emulator controller via a TCP connection, in step S506.

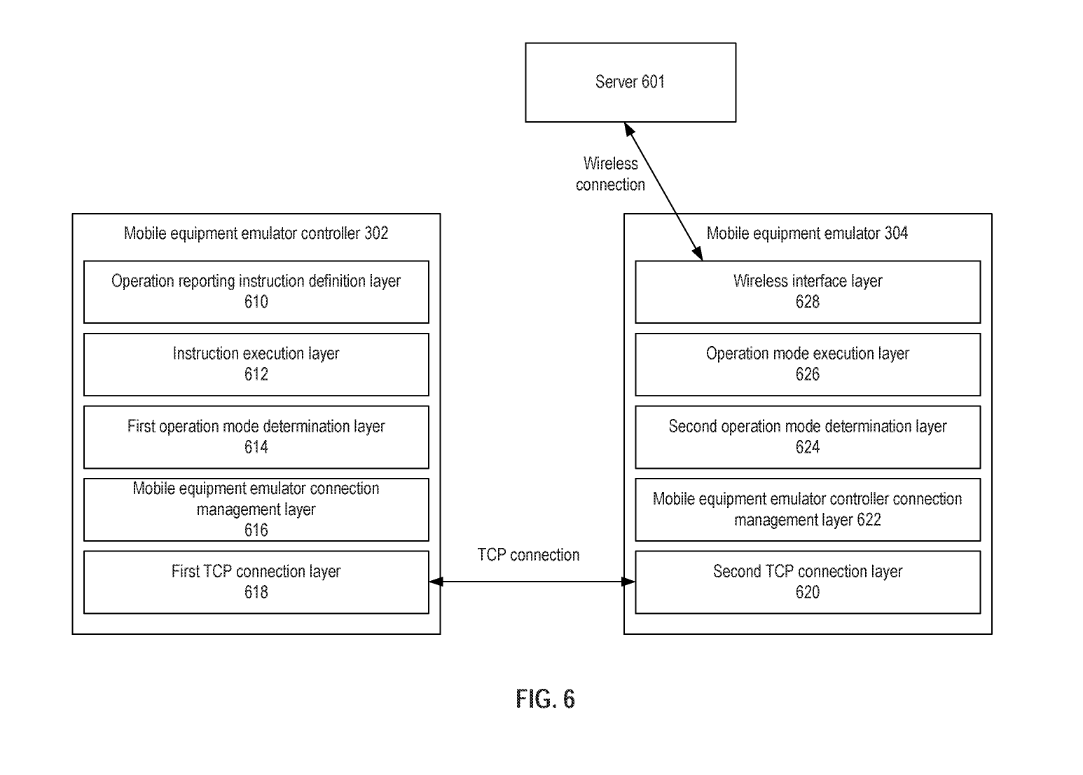

Reference is now made to FIG. 6, which illustrates an exemplary system 600 for acquiring network status data according to embodiments of the present disclosure. As illustrated in FIG. 6, system 600 includes mobile equipment emulator controller 302 and mobile equipment emulator 304 of FIG. 3. Mobile equipment emulator controller 302 can be communicatively coupled with mobile equipment emulator 304 via, for example, a TCP connection. Mobile equipment emulator 304 can be communicatively coupled with a server 601 via, for example, a wireless connection.

In some embodiments, mobile equipment emulator controller 302 includes an operation reporting instruction definition layer 610, an instruction execution layer 612, an operation mode determination layer 614, a mobile equipment emulator connection management layer 616, and a first TCP connection layer 618. Mobile equipment emulator 304 includes a second TCP connection layer 620, a mobile equipment emulator controller management layer 622, a second operation mode determination layer 624, an operation mode execution layer 626, and a wireless interface layer 628.

In general, the words “layer” and “module,” as used herein, refers to logic embodied in hardware or firmware, or to a collection of software instructions, possibly having entry and exit points, written in a programming language, such as, for example, Java, Lua, Go, C or C++. A software layer can include multiple modules, and vice versa. Each software layer and module can be compiled and linked into an executable program, installed in a dynamic link library, or written in an interpreted programming language such as, for example, BASIC, Perl, or Python. It will be appreciated that software layers and modules can be callable from other modules, layers, or from themselves, and/or can be invoked in response to detected events or interrupts. Software layers and modules configured for execution on computing devices (e.g., a processor) can be provided on a computer readable medium, such as a compact disc, digital video disc, flash drive, magnetic disc, or any other tangible medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedded in firmware, such as an EPROM. It will be further appreciated that hardware modules can be comprised of connected logic units, such as gates and flip-flops, and/or can be comprised of programmable units, such as programmable gate arrays or processors. The layers, modules or computing device functionalities described herein can be implemented as software modules, but can be represented in hardware or firmware. Generally, the layers and modules described herein refer to logical layers and modules that can be combined with other layers and modules, or divided into sub-layers and sub-modules despite their physical organization or storage.

Referring back to FIG. 6, the operation reporting instruction definition layer 610 can be configured to provide an association between an operation reporting instruction and a set of operations for acquiring network status data. As an illustrative example, an operation reporting instruction can be associated with instructing a certain mobile equipment emulator to transmit one or more ping commands to an address associated with a Uniform Resource Identifier (URL) of a web site. The operation reporting instruction can also be associated with a mobile equipment emulator and with a server (or with a mobile equipment emulator controller). The associations can be stored in the aforementioned configuration data that stores information associated with a list of mobile equipment emulator. Instruction execution layer 612 can be configured to acquire the configuration data, and to extract information about a mobile equipment emulator, the server (or the mobile equipment emulator controller), and the method to be performed for acquiring network status data from the configuration data. Instruction execution layer 612 can also validate the extracted information. Instruction execution layer 612 can provide the extracted information to operation mode determination layer 614. Instruction execution layer 612 can also provide a result of execution of an operation reporting instruction (e.g., network status data) for displaying. In some embodiments, instruction execution layer 612 can perform at least a part of step S101a and S101b of FIG. 2.

First operation mode determination layer 614 can be configured to determine, based on the information about the method for acquiring network status data provided by instruction execution layer 612, whether the operation reporting instruction is associated with a local operation mode or with an interactive operation mode. First operation mode determination layer 614 can also generate TCP payload data for the operation reporting instruction, and insert operation mode indication information in the TCP payload data for future transmission. In some embodiments, first operation mode determination layer 614 can perform at least a part of step S101c of FIG. 2 and S102 of FIG. 1.

Mobile equipment emulator connection management layer 616 can be configured to manage the TCP connections with mobile equipment emulator, which can include creation and termination of TCP connections and associating the TCP connections with the mobile equipment emulator. In some embodiments, mobile equipment emulator connection management layer 616 can perform at least a part of step S101d of FIG. 2.

First TCP connection layer 618 can be configured to transmit TCP payload data, prepared by first operation mode determination layer 614, to mobile equipment emulator 304 via a TCP connection formed between first TCP connection layer 618 and second TCP connection layer 620 of mobile equipment emulator 304. First TCP connection layer 618 can also receive network status data from second TCP connection layer 620 via the TCP connection. In some embodiments, first TCP connection layer 618 can perform at least a part of steps S102 and S103 of FIG. 1, while second TCP connection layer 620 can perform at least a part of step S506 of FIG. 5.

Mobile equipment emulator controller connection management layer 622 can be configured to manage a TCP connection with a mobile equipment emulator controller (e.g., mobile equipment emulator controller 304). In some embodiments, mobile equipment emulator controller connection management layer 622 can manage a TCP connection between mobile equipment emulator 304 and a plurality of mobile equipment emulator controllers, which allows mobile equipment emulator 304 to respond to operation reporting instructions from the different mobile equipment emulator controllers.

Second operation mode determination layer 624 can be configured to determine a mode of operation (e.g., local operation mode, interactive operation mode, etc.) based on the operation mode indication information in the TCP payload data received by second TCP connection layer 620. In some embodiments, second operation mode determination layer 624 can perform at least a part of step S501 of FIG. 5.

Operation mode execution layer 626 can be configured to execute the operation reporting instruction based on the operation mode determined by second operation mode determination layer 624. In some embodiments, operation mode execution layer 626 can perform at least a part of steps S503, S504, and S505.

Wireless interface layer 628 can be configured to establish a wireless connection between mobile equipment emulator 304 and server 601, which allows mobile equipment emulator 304 to transmit and receive data from server 601 either in the local operation mode or in the interactive operation mode.

With embodiments of the present disclosure, an apparatus (e.g., a mobile equipment emulator controller) can transmit an operation reporting instruction to a mobile equipment emulator, to cause the mobile equipment emulator to acquire and transmit network status data. The apparatus can also configure the mobile equipment emulator to transmit network status data continuously and periodically over a period of time, and to coordinate the acquisition of network status data between different devices. The mobile equipment emulator controller can control a plurality of mobile equipment emulator distributed across different geographical locations to acquire network status data in those locations. Based on the network status data, the mobile equipment emulator controller (or some other apparatuses) can detect or predict network access failure, and provide notification about the failure. Further, since specific instructions for acquiring network status data are provided to the mobile equipment emulator, any updates to the operations of acquiring network status data can be made at the mobile equipment emulator controller, thereby enhancing the scalability of the system.

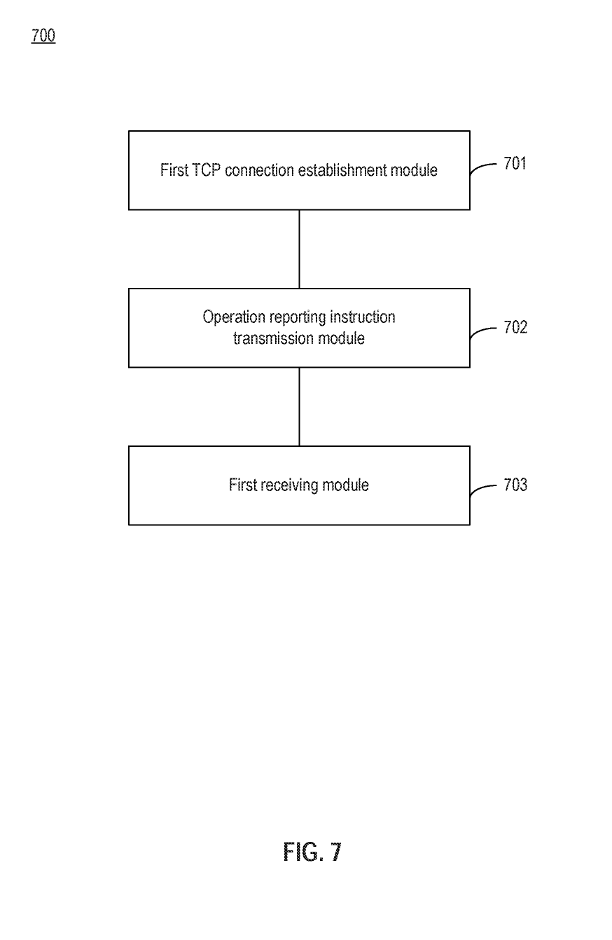

Reference is now made to FIG. 7, which illustrates the block diagrams of an exemplary mobile equipment emulator controller 700. As shown in FIG. 7, mobile equipment emulator controller 700 includes a TCP connection establishment module 701, an operation reporting instruction transmission module 702, and a first receiving module 703. These modules can be configured to be part of or to include at least some of operation reporting instruction definition layer 610, instruction execution layer 612, operation mode determination layer 614, mobile equipment emulator connection management layer 616, and first TCP connection layer 618 of mobile equipment emulator controller 302 of FIG. 6.

First TCP connection establishment module 701 can be configured to establish a TCP connection with a mobile equipment emulator. In some embodiments, first TCP connection establishment module 701 can also include (not shown in FIG. 7): a configuration acquisition module configured to acquire configuration data for network status monitoring, a mobile equipment emulator information acquisition module configured to acquire a list of mobile equipment emulator and associated information from the configuration data, a first transmission module configured to transmit a TCP connection request to at least some of the mobile equipment emulator in the list, and recording module configured to record a mapping between a mobile equipment emulator and an associated TCP connection. In some embodiments, first TCP connection establishment module 701 can perform at least a part of step S101 of FIG. 1 and steps S101a-S101d of FIG. 2.

Operation reporting instruction transmission module 702 can be configured to transmit an operation reporting instruction to a mobile equipment emulator. In some embodiments, operation reporting instruction transmission module 702 can also include (not shown in FIG. 7): a thread creation module configured to create an independent thread for transmitting an operation reporting instruction, a mapping module configured to map the operation reporting instruction for the mobile equipment emulator to the independent thread, an inquiry module configured to determine a TCP connection associated with the mobile equipment emulator, and a second transmission module configured to transmit the operation reporting instruction to the mobile equipment emulator via a TCP connection associated with the mobile equipment emulator. In some embodiments, operation reporting instruction transmission module 702 can perform at least a part of step S102 of FIG. 1 and steps S102a-S102c of FIG. 4.

First receiving module 703 can be configured to receive network status data from the mobile equipment emulator. In some embodiments, first receiving module 703 can perform at least a part of step S103 of FIG. 1.

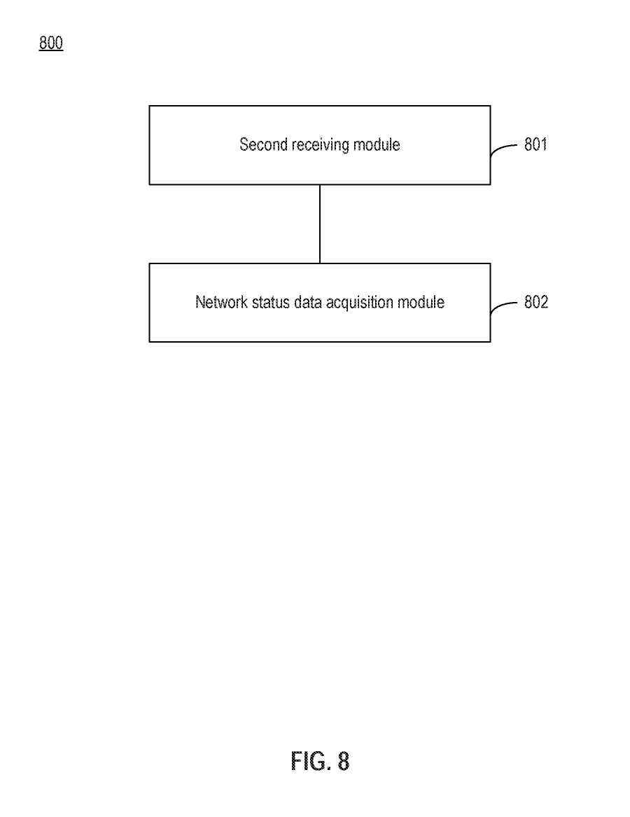

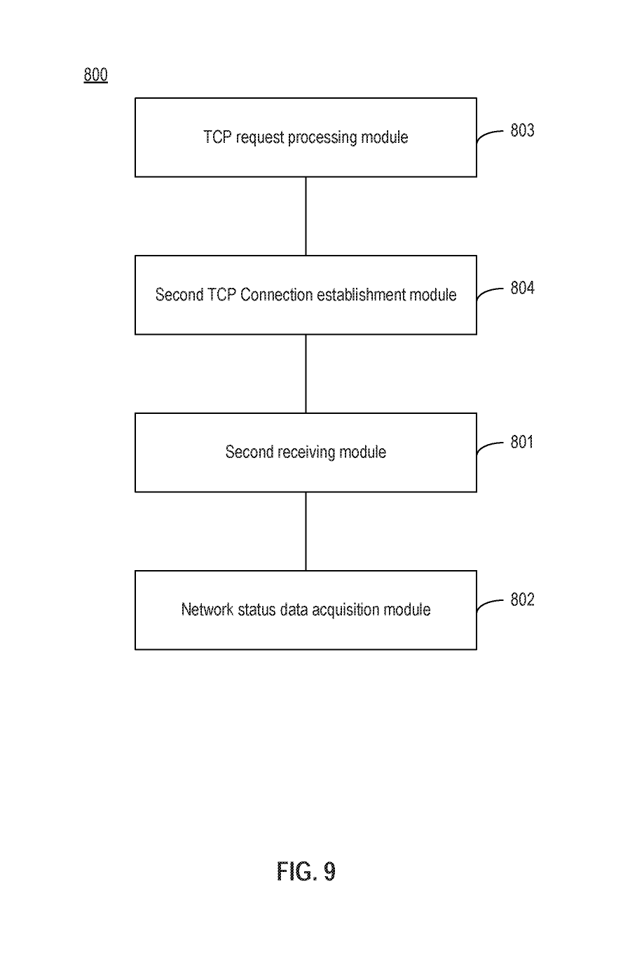

Reference is now made to FIG. 8, which illustrates the block diagrams of an exemplary mobile equipment emulator 800. As shown in FIG. 8, mobile equipment emulator 800 includes a second receiving module 801 and a network status data acquisition module 802. These modules can be configured to be part of or to include at least some of second TCP connection layer 620, mobile equipment emulator controller management layer 622, second operation mode determination layer 624, operation mode execution layer 626, and wireless interface layer 628 of mobile equipment emulator controller 304 of FIG. 6. Second receiving module 801 can be configured to receive, from a mobile equipment emulator controller, an operation reporting instruction. Network status data acquisition module 802 can be configured to acquire network status data based on the operation reporting instruction, and to transmit the acquired network status data to the mobile equipment emulator controller. In some embodiments, as shown in FIG. 9, mobile equipment emulator 800 can further include a TCP request processing module 803 configured to detect a TCP connection request transmitted from, for example, first TCP connection establishment module 701 of a mobile equipment emulator controller. Mobile equipment emulator 800 can also include a second TCP connection establishment module 804 configured to establish a TCP connection with the mobile equipment emulator controller, after receiving the TCP connection request. In some embodiments, the modules of mobile equipment emulator 800 can perform at least some of method 500.

In some embodiments, network status data acquisition module 802 further comprises (not shown in FIGS. 8 and 9): a third receiving module configured to receive operation reporting instruction from a mobile equipment emulator controller, a local operation module configured to acquire network status data according to the operation reporting instruction, and an interactive operation module configured to establish a network connection with a server that provides network resources, and to transmit the operation reporting instruction to the server to cause the server to acquire network status data according to the operation reporting instruction, and to transmit the network status data to the mobile equipment emulator. In some embodiments, network status data acquisition module 802 can perform at least some of steps S502-S505 of FIG. 5.

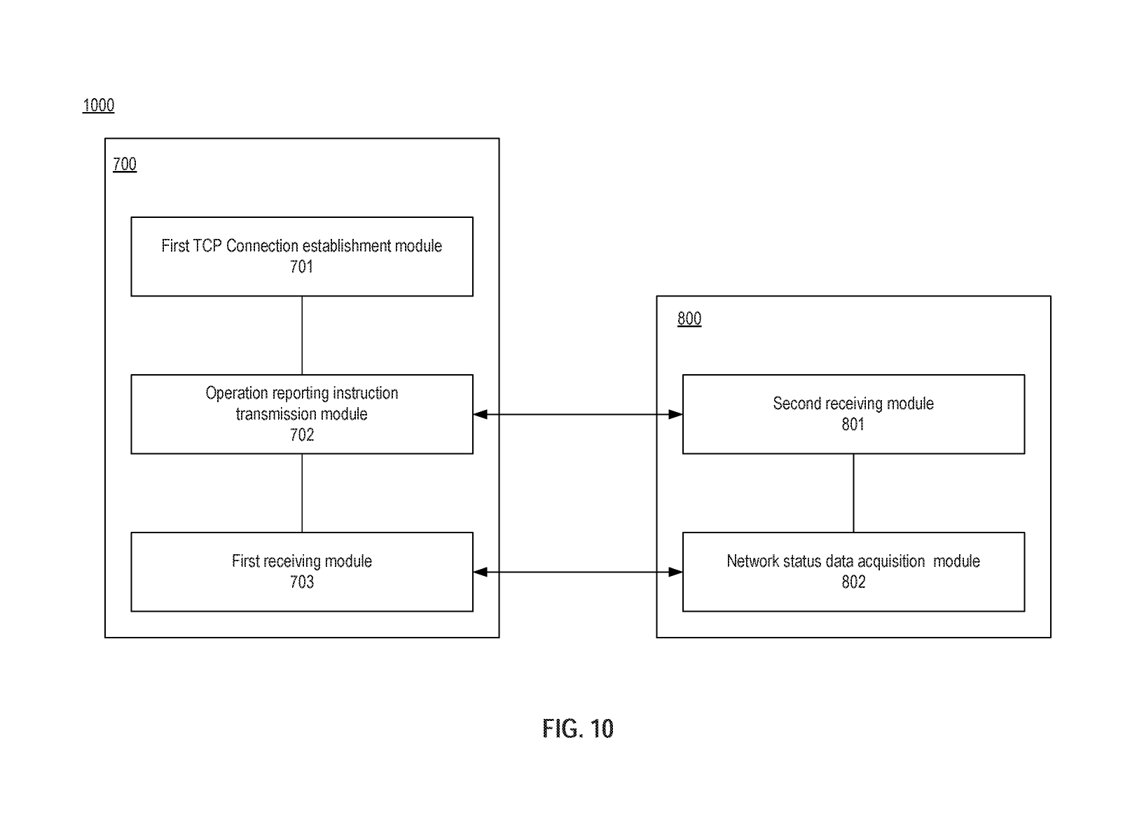

FIG. 10 includes an exemplary system 1000 for acquiring network status data, consistent with embodiments of the present disclosure. As shown in FIG. 10, system 1000 can include mobile equipment emulator controller 700 of FIG. 7 and mobile equipment emulator 800 of FIG. 8. Operation reporting instruction transmission module 702 of mobile equipment emulator controller 700 can transmit TCP data including operation reporting instructions to second receiving module 801 of mobile equipment emulator 800 via a TCP connection. After receiving the operation reporting instructions, network status data acquisition module 802 of mobile equipment emulator 800 can acquire network status data and transmit the data to first receiving module 703 of mobile equipment emulator controller 700, also via the TCP connection.

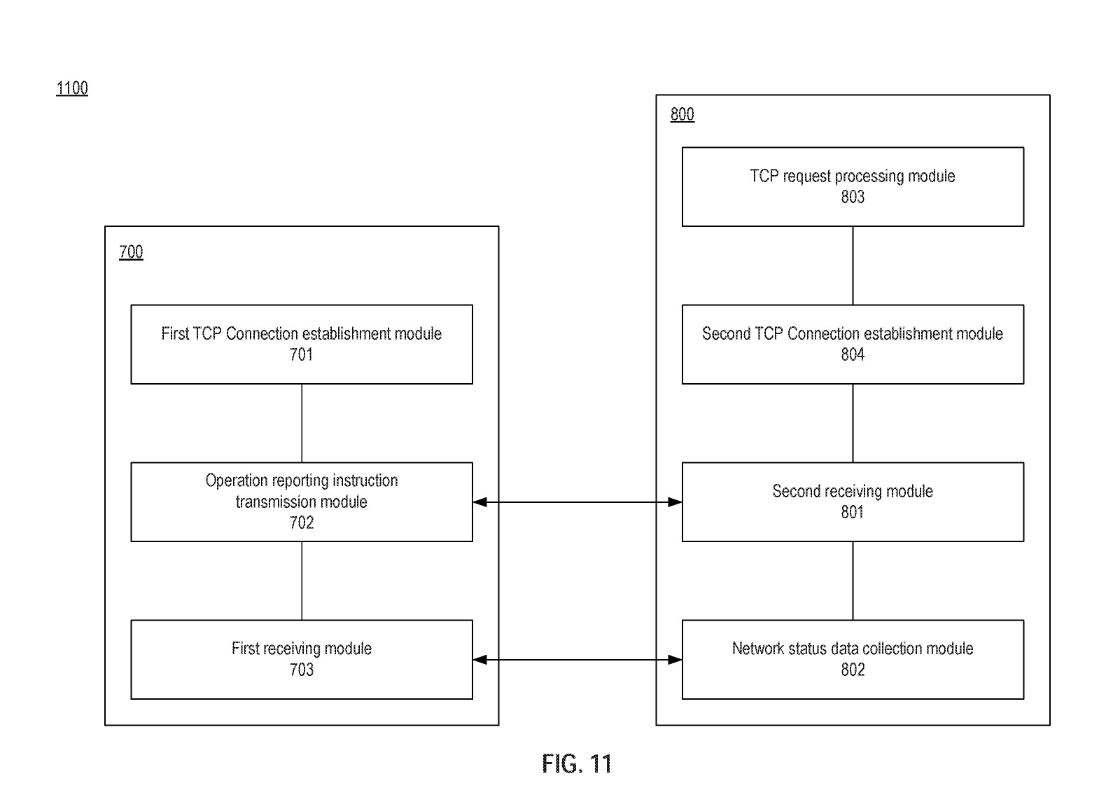

FIG. 11 includes an exemplary system 1100 for acquiring network status data, consistent with embodiments of the present disclosure. As shown in FIG. 11, system 1100 can include mobile equipment emulator controller 700 of FIG. 7 and mobile equipment emulator 800 of FIG. 9. The TCP request processing module 803 and second TCP connection establishment module 804 of mobile equipment emulator 800 can be configured to receive a TCP request from mobile equipment emulator controller 700 and to establish a TCP connection with the mobile equipment emulator controller.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware. Furthermore, the present invention may take the form of a computer program product embodied in one or more computer available storage media (including but not limited to a magnetic disk memory, a CD-ROM, an optical memory and so on) containing computer available program codes.

Embodiments of the present disclosure are described with reference to flow diagrams and/or block diagrams of methods, devices (systems) and computer program products according to embodiments of the present invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general-purpose computer, a special-purpose computer, an embedded processor, or other programmable data processing devices to produce a machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer readable memory that can direct a computer or other programmable data processing devices to function in a particular manner, such that the instructions stored in the computer readable memory produce a manufactured product including an instruction means which implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions which are executed on the computer or other programmable devices provide steps for implementing the functions specified in one or more flows in the flow diagrams and/or one or more blocks in the block diagrams.

In a typical configuration, a computer device includes one or more Central Processing Units (CPUs), an input/output interface, a network interface and a memory.

The memory may include forms of a volatile memory, a random access memory (RAM) and/or non-volatile memory and the like, such as a read-only memory (ROM) or a flash RAM in a computer readable medium. The memory is an example of the computer readable medium.

The computer readable medium includes non-volatile and volatile media, removable and non-removable media, wherein information storage can be implemented with any method or technology. Information may be modules of computer readable instructions, data structures and programs or other data. Examples of a computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices or any other non-transistory media which may used to store information capable of being accessed by a computer device. According to the definition of the context, the computer readable medium does not include transitory media, such as modulated data signals and carrier waves.

It will be further noted that the terms “comprises”, “comprising” or any other variations are intended to cover non-exclusive inclusions, so as to cause a process, method, commodity or device comprising a series of elements to not only comprise those elements, but also comprise other elements that are not listed specifically, or also comprise elements that are inherent in this process, method, commodity or device. Therefore, the element defined by a sentence “comprising a . . . ” does not preclude the presence of other same elements in the process, method, commodity or device including said elements under the condition of no more limitations.

As will be understood by those skilled in the art, embodiments of the present invention may be embodied as a method, a system or a computer program product. Accordingly, the present invention may take the form of an entirely hardware embodiment, an entirely software embodiment or an embodiment combining software and hardware. Furthermore, the present invention may take the form of a computer program product embodied in one or more computer available storage media (including but not limited to a magnetic disk memory, a CD-ROM, an optical memory and so on) containing computer available program codes.

One of ordinary skill in the art will understand that the above described embodiments can be implemented by hardware, or software (program codes), or a combination of hardware and software. If implemented by software, it may be stored in the above-described computer-readable media. The software, when executed by the processor can perform the disclosed methods. The computing units and the other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the present disclosure will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method of acquiring network status data, the method being performed by a mobile equipment emulator controller, the method comprising:
establishing a link with a first mobile equipment emulator;
transmitting, over the link, an operation reporting instruction to the first mobile equipment emulator, wherein the operation reporting instruction is associated with a set of operations to be performed by the first mobile equipment emulator to acquire network status data, and wherein the operation reporting instruction is configured to cause the first mobile equipment emulator to perform the set of operations; and
receiving, over the link, the network status data from the first mobile equipment emulator, after the operation reporting instruction is transmitted.

2. The method of claim 1, further comprising:
acquiring configuration data that stores information associated with a plurality of mobile equipment emulator including the first mobile equipment emulator configured to receive one or more operation reporting instructions from the mobile equipment emulator controller;
determining to establish the link with the first mobile equipment emulator based on the configuration data; and
storing a mapping between the link and the first mobile equipment emulator.

3. The method claim 1, wherein the configuration data includes location information of the first mobile equipment emulator; and wherein the determination to establish the link is based on the location information.

4. The method of claim 1, further comprising:
creating an independent thread for transmitting the operation reporting instruction; and
mapping the operation reporting instruction to the independent thread.

5. The method of claim 1, further comprising:
determining a mode of acquiring network status data;
generating indication information associated with the mode of acquiring network status data; and
transmitting the indication information with the operation reporting instruction to the first mobile equipment emulator.

6. The method of claim 1, wherein the mode of acquiring network status data includes an interactive operation mode, wherein the operation reporting instruction is configured to cause the first mobile equipment emulator to transmit an access request for network resources to the server.

7. The method of claim 1, wherein the mode of acquiring network status data includes a local operation mode, wherein the operation reporting instruction is configured to cause the first mobile equipment emulator to transmit a network connectivity diagnosis command to the server.

8. A mobile equipment emulator controller for acquiring network status data, wherein the mobile equipment emulator controller comprises:
a memory device that stores a set of instructions; and
a hardware processor that executes the set of instructions to:
establish a link with a first mobile equipment emulator;
transmit, over the link, an operation reporting instruction to the first mobile equipment emulator, wherein the operation reporting instruction is associated with a set of operations to be performed by the first mobile equipment emulator to acquire network status data, and wherein the operation reporting instruction is configured to cause the first mobile equipment emulator to perform the set of operations; and
receive, over the link, the network status data from the first mobile equipment emulator, after the operation reporting instruction is transmitted.

9. The mobile equipment emulator controller of claim 8, wherein the hardware processor further executes the set of instructions to:
acquire configuration data that stores information associated with a plurality of mobile equipment emulator including the first mobile equipment emulator that receives one or more operation reporting instructions from the mobile equipment emulator controller;
determine to establish the link with the first mobile equipment emulator based on the configuration data; and
store a mapping between the link and the first mobile equipment emulator.

10. The mobile equipment emulator controller of claim 8, wherein the configuration data includes location information of the first mobile equipment emulator; and wherein the determination to establish the link is based on the location information.

11. The mobile equipment emulator controller of claim 8, wherein the hardware processor further executes the set of instructions to:
create an independent thread for transmitting the operation reporting instruction; and
map the operation reporting instruction to the independent thread.

12. The mobile equipment emulator controller of claim 8, wherein the hardware processor further executes the set of instructions to:
determine a mode of acquiring network status data;
generate indication information associated with the mode of acquiring network status data; and
transmit the indication information with the operation reporting instruction to the first mobile equipment emulator.

13. The mobile equipment emulator controller of claim 8, wherein the mode of acquiring network status data includes an interactive operation mode, wherein the operation reporting instruction is configured to cause the first mobile equipment emulator to transmit an access request for network resources to the server.

14. The mobile equipment emulator controller of claim 8, wherein the mode of acquiring network status data includes a local operation mode, wherein the operation reporting instruction is configured to cause the first mobile equipment emulator to transmit a network connectivity diagnosis command to the server.

15. A non-transitory computer readable medium storing instructions that are executable by one or more processors of the mobile equipment emulator controller to cause the mobile equipment emulator controller to execute a method of acquiring network status data, the method comprising:
establishing a link with a first mobile equipment emulator;
transmitting, over the link, an operation reporting instruction to the first mobile equipment emulator, wherein the operation reporting instruction is associated with a set of operations to be performed by the first mobile equipment emulator to acquire network status data, and wherein the operation reporting instruction is configured to cause the first mobile equipment emulator to perform the set of operations; and
receiving, over the link, the network status data from the first mobile equipment emulator, after the operation reporting instruction is transmitted.

16. The medium of claim 15, wherein the instructions that are executable by one or more processors of the mobile equipment emulator controller to cause the mobile equipment emulator controller to further perform:
acquiring configuration data that stores information associated with a plurality of mobile equipment emulator including the first mobile equipment emulator that receives one or more operation reporting instructions from the mobile equipment emulator controller;
determining to establish the link with the first mobile equipment emulator based on the configuration data; and
storing a mapping between the link and the first mobile equipment emulator.

17. The medium of claim 15, wherein the configuration data include location information of the first mobile equipment emulator; and wherein the determination to establish the link is based on the location information.

18. The medium of claim 15, wherein the instructions that are executable by one or more processors of the mobile equipment emulator controller to cause the mobile equipment emulator controller to further perform:
creating an independent thread for transmitting the operation reporting instruction; and
mapping the operation reporting instruction to the independent thread.

19. The medium of claim 15, wherein the instructions that are executable by one or more processors of the mobile equipment emulator controller to cause the mobile equipment emulator controller to further perform:
determining a mode of acquiring network status data;
generating indication information associated with the mode of acquiring network status data; and
transmitting the indication information with the operation reporting instruction to the first mobile equipment emulator.

20. The medium of claim 15, wherein the mode of acquiring network status data includes one of: an interactive operation mode, wherein the operation reporting instruction is configured to cause the first mobile equipment emulator to transmit an access request for network resources to the server; and a local operation mode, wherein the operation reporting instruction is configured to cause the first mobile equipment emulator to transmit a network connectivity diagnosis command to the server.
